(19) United States
(12) Patent Application Publication
(10) Pub. No.: US 2004/0101044 A1
(43) Pub. Date: May 27, 2004

(54) Device with several transport current paths for receiving digital radio signals

(76) Inventors: Bernhard Horn, Forchheim (DE); Heinrich Thoma, Dentlein (DE)

Correspondence Address: Quarles & Brady, 411 E Wisconsin Ave, Milwaukee, WI, 53202-4497, US

(21) Appl. No.: 10/470,795

(22) PCT Filed: Jan. 29, 2002
(86) PCT No.: PCT/EP02/00872

(30) Foreign Application Priority Data
Feb. 1, 2001 (DE) 101 04 440.2

(51) Int. Cl. H04N 7/12

(52) U.S. Cl. 375/240.01

(57) ABSTRACT

The invention relates to a device for receiving digital radio signals, comprising a digital radio receiver which has several transport current paths and at least two signal sinks. Switching means which are used to connect each of the transport current paths to each of the two signal sinks are also provided.

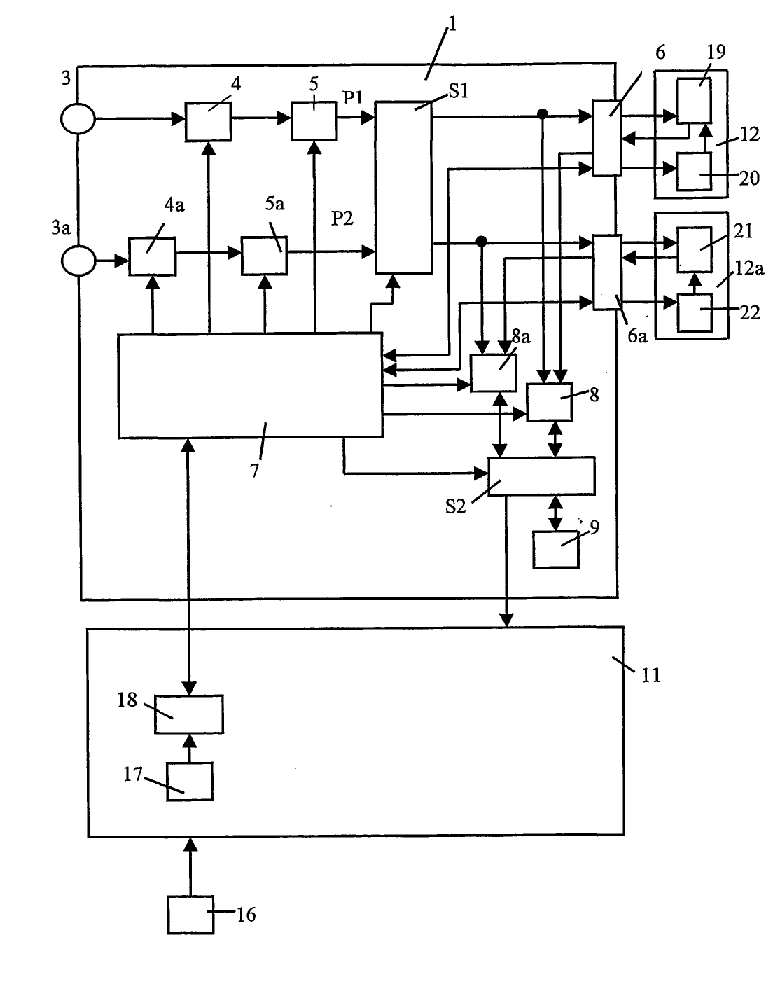

### DESCRIPTION

The invention concerns a device for reception of digital radio signals.

So-called settop boxes, provided to receive analog and/or digital satellite radio signals, are already known. Such settop boxes are ordinarily made in the form of an independent device and are connected between the external unit of a satellite receiver and an ordinary television receiver. Conversion of the signals derived from the external unit of the satellite receiver to signals that are fed to an ordinary television receiver through its HF input or its Euro-AV socket occurs in such a settop box.

Designing the assemblies of a settop box in the form of a module and integrating this module in the housing with the television receiver are also already known.

Digital radio signals, transmitted via radio satellites, can contain digital teletext data and other digital data, in addition to digital audio and video data, which can be received with a digital receiver. It is also desirable to have access to Internet data and/or other data services by means of a digital receiver. If one wants to be able to receive and process a number of types of digital data with a single digital receiver, it must be tolerated that the manufacturing and therefore final sales price for digital receivers are high. Such digital receivers are also complicated in design, so that high requirements are imposed on equipment developers. In addition, under practical conditions, most buyers of such a digital receiver will never use a variety of functions of the device. These device buyers, however, must pay the mentioned high prices for the digital receivers.

These shortcomings are avoided in a device for reception of digital radio signals, as described in DE 10007710.2. This known device has an additional module that is connected to a digital receiver via a device interface. The additional module is provided with a signal processing unit, to which an MPEG transport stream, derived from the received signal, is made available on the input side from the digital receiver. The output signal of the signal processing unit of the additional module goes back to the digital receiver via the device interface and is further processed there.

The underlying task of the invention is to provide a way to expand the use possibilities of the known device.

This task is solved by a device with the features stated in claim 1. Advantageous embodiments and modifications of the invention are apparent from the dependent claims.

The advantages of the invention, in particular, consist of the fact that each of the transport stream paths provided in the digital radio receiver can be connected to each of the signal sinks. This offers the possibility during simultaneous reception of different radio programs, especially coded and encrypted radio programs with the same coding, to decode one of these programs by means of an available decoder, play it back in decoded form via a playback device and store the other program in coded or encrypted form. The signals stored in coded form can be decoded at a later time, when the decoder is no longer needed for other purposes and played back in decoded form or stored again.

The digital radio receiver, which can be a settop box or a digital television receiver, preferably has several interfaces, via which it is connected to several additional modules. Each of these additional modules contains one or more signal processing units, for example, a decoder, an MP3 audio signal decoder, a Dolby surround decoder, etc. Each of these additional modules can be connected via the claimed switching device to each of the signal sinks, so that the use possibilities of a digital radio receiver are also expanded in this respect.

Other advantageous properties of the invention are apparent from their explanation with reference to the FIGURE, which shows a block diagram of the device for reception of digital radio signals.

The depicted device contains a digital radio receiver 1, an additional module 12 connected to the digital radio receiver via an interface 6, an additional module 12a connected to the digital radio receiver via an interface 6a, and a television 11 connected to the digital radio receiver. The latter has a remote control 16 as operating unit, whose infrared output signals are detected by a remote receiver 17 and sent to the control unit 18 of the television. The control unit converts the entered operating commands of the control signals for the additional assemblies of the television, and is also in bidirectional connection with the control unit 7 of the digital radio receiver 1.

The digital radio receiver, which is a settop box in the depicted practical example, has input terminals 3 and 3a. The input terminal 3 is a satellite signal input terminal, via which digital signals, derived from a satellite antenna, are fed to the digital radio receiver. The input terminal 3a is an input terminal connected to a cable transmission line, via which digital signals transmitted via cable are fed to the digital radio receiver.

The input terminal 3 is connected to a receiver unit, having a tuner 4 and a demodulator 5. The demodulator 5 furnishes digital data in the form of an MPEG transport stream at its output. This transport stream contains a multiplex of several services, in which the signals are transmitted in the form of packets. A service can contain one or more television programs, one or more radio programs, additional data for the radio and television programs, like teletext data, multilanguage audio data, a program guide or subtitle data. A service can also contain data services or programs in the EDP sense. The tuner 4 and demodulator 5 are controlled by control signals that are generated by a central control unit 7 of the digital radio receiver.

The input terminal 3a is connected to a receiver unit, having a tuner 4a and a demodulator 5a. The demodulator 5a also furnishes digital data in the form of an MPEG transport stream at its output. This transport stream contains a multiplex of several services, in which the signals are transmitted in the form of packets. A service can contain one or more television programs, one or more radio programs, additional data for the radio or television programs, like teletext data, multilanguage audio data, a program guide or subtitle data. In addition, a service can also contain data services or programs in the EDP sense. The tuner 4a and demodulator 5a are controlled by control signals that are also generated by the central control unit 7 of the digital radio receiver.

MPEG transport stream paths P1 and P2 are consequently present at the output of demodulators 5 and 5a, which are connected to the inputs of a first switch S1.

The MPEG transport stream present on the upper output of switch S1 is sent to a signal processing unit 8 and to interface 6. The MPEG transport stream reaches the additional module 12 by interface 6, which has a decoder 19 and a control unit 20. The control unit 20 of the additional module 12 is in bidirectional connection via interface 6 with the control unit 7 of the digital radio receiver 1. For example, transmission of ID signals for a subdata stream of the MPEG transport stream to be decoded, which are required for signal decoding in the additional module, occurs via this connection. The signals decoded in the additional module 12 are fed back to the digital radio receiver 1 via interface 6 and sent to the signal processing unit 8 there.

The MPEG transport stream present on the lower output of switch S1 is sent to a signal processing unit 8a and to interface 6a. The MPEG transport stream reaches the additional module 12a via interface 6a, which has an MP3 decoder 21 and a control unit 22. The control unit 22 of additional module 12a is in bidirectional connection via interface 6a with the control unit 7 of the digital radio receiver 1. For example, transmission of identification signals for a subdata stream of the MPEG transport stream to be decoded, which are required in the additional module for signal decoding, occurs via this connection. The signals decoded in additional module 12a are fed back to the digital radio receiver 1 via interface 6a and sent there to the signal processing unit 8a.

The outputs of the signal processing units 8 and 8a are connected to the inputs of a second switch S2. The signals present on the left lower output of switch S2 are sent to the television 11 and displayed on its screen. The signals present on the right lower output of switch S2 are fed to a hard disk 9 and stored there.

Switches S1 and S2, additional modules 12 and 12a, as well as the signal processing units 8 and 8a, are also controlled by the central control unit 7.

Each of the transport stream paths P1 and P2 can be connected to each of the signal sinks 9 and 11 via switching devices S1 and S2. Each of the additional modules 12 and 12a can also be connected via switch S2 to each of the signal sinks 9 and 11. This is explained as an example below.

If the user would like to playback live, by means of a television 11, a certain television transmission that is transmitted coded by satellite, he enters the corresponding operating commands via the television remote 16. These are received by the remote receiver 17 and sent to the control unit 18 and television 11. The control unit 18 addresses, in response to the entered commands, a transmitter memory and reads out corresponding characteristic data from it for television transmission. These data include information on the signal source “satellite”, the receiving frequency, the identification of the subdata stream corresponding to the television transmission, the type of coding of the signal, etc. These characteristic data were stored in the context of programming of the transmitter memory during startup of the device and entered with the operating unit.

The characteristic data read out from the transmitter memory of the desired television transmission are transmitted from the control unit 18 of the television 11 to the control unit 7 of settop box 1. The control unit 7 generates control signals for the receiving part 4, 5, switch S1, additional module 12, signal processing unit 8 and switch S2, so that the desired television transmission that is transmitted via the transport stream path P1 is decoded in additional module 12 and, from there, fed by interface 6, signal processing unit 8 and switch S2 to the television 11 and played back on its screen.

If the user would now like to receive and playback a second simultaneously transmitted television transmission that is transmitted coded with the same coding as the above television transmission via cable, this is done as follows:

The user enters corresponding operating commands by means of the remote control 16. These are received by the remote receiver 17 and sent to the control unit 18 of television 11. The control unit 18 addresses, in response to the entered commands, the transmitter memory and reads out the characteristic data there corresponding to the second television transmission. This information includes the signal source “cable”, the receiving frequency, the identification of the subdata stream corresponding to the second television transmission, the type of coding of the signal, etc.

The characteristic data of the second television transmission read out from the transmitter memory are transmitted from the control unit 18 of the television 11 to the control unit 7 of settop box 1. The control unit 7 recognizes that decoding is also necessary in additional module 12 for playback of the second television transmission. The additional module 12, however, is required at the moment for decoding of the first television transmission, transmitted in transport stream path P1, and is therefore not available now. Consequently, the control unit 7 generates control signals for receiving part 4a, 5a, switch S1, signal processing unit 8a and switch S2, so that the desired second television transmission, transmitted in transport stream path P2, is fed in coded form via switch S2 to the hard disk memory 9 and stored there.

If, at a later time, the decoder contained in additional module 12 is no longer required for decoding of the first television transmission contained in transport stream path P1, decoding of the second television transmission, stored coded in hard disk memory 9, can then be retrieved. The decoded second television transmission is the available for playback on the screen of television 11 or for decoded recording on a recording device (not shown).

A decision as to which of the simultaneously transmitted television transmission is assigned the higher priority can be made by the user by means of the operating unit. For example, the control unit of the device, on recognition of such a simultaneous transmission of two television transmissions of the same coding, initiates a screen display, through which the user is then asked to state which of the transmissions is to be decoded and played back live and which of the transmissions is to be stored coded.

As an alternative, use of a priority list stored in a memory is also possible. For example, if one of the two television transmissions is to be recorded by means of a video recorder connected to the television receiver and the other viewed on the screen, the transmission to be viewed on the screen is assigned a higher priority. In this case, decoding and playback of the transmission to be displayed on the screen occurs in real time, as well as storage of the transmission to be recorded on the video recorder in coded form in the hard disk memory. If the decoder is no longer required for other purposes, the coded signals are decoded can be played back from the hard disk memory and then recorded in decoded form by means of the video recorder.

The beginning of playback of coded signals from the hard disk memory for purposes of decoding can occur either in response to an operating command entered by the operating unit or automatically, for example, when the user switches the device into readiness operation. The speed of decoding of coded signals played back from the hard disk memory can be carried out with the maximum possible symbol rate.

1. Device for reception of digital radio signals, with
a digital radio receiver, having several transport stream paths,
at least two signal sinks and
switching devices (S1, S2), via which each of the transport stream paths (P1, P2) can be connected to each of the two signal sinks (9, 11), where
the switching devices have a first switch (S1), via which each of the transport stream paths (P1, P2) can be connected via a first interface (6) of the digital radio receiver (1) to a first additional module (12).

2. Device according to claim 1,
characterized by the fact that
the first transport stream path serves to transmit a first coded radio signal, the second transport stream path is provided for simultaneous transmission of a second coded radio signal, whose coding agrees with the coding of the first radio signal, the device having only one decoder for decoding of signals with the mentioned coding, and a control unit (7) controls switching devices (S1, S2), so that one of the coded radio signals is sent in decoded form to the first signal sink and the other of the coded radio signals is sent in coded form to the second signal sink.

3. Device according to claim 1 or 2,
characterized by the fact that
one of the transport stream paths (P1) serves for transmission of the MPEG transport stream, derived from a satellite signal input terminal (3) of the digital radio receiver (1).

4. Device according to one of the claims 1 to 3,
characterized by the fact that
one of the transport stream paths (P2) serves for transmission of a MPEG transport stream, derived from a cable signal input terminal (3a) or a terrestrial antenna input terminal of the digital radio receiver (1).

5. Device according to one of the preceding claims,
characterized by the fact that
the switching devices have a first switch (S1), via which each of the transport stream paths (P1, P2) can be directly connected to a signal processing unit (8, 8a) of the digital radio receiver (1).

6. Device according to claim 5,
characterized by the fact that
the digital radio receiver (1) has two parallel-connected signal processing units (8, 8a), whose outputs are connected to a second switch (S2), via which each of the signal processing units (8, 8a) can be connected to each of the two signal sinks (9, 11).

7. Device according to one of the preceding claims,
characterized by the fact that
one of the signal sinks is a signal playback unit (11) and the other a memory unit (9).

8. Device according to claim 7,
characterized by the fact that
the memory unit is a hard disk memory (9).

9. Device according to one of the preceding claims,
characterized by the fact that
the control unit (7) is a central control unit of the digital radio receiver (1) that serves for generation of switching control signals for switching devices (S1, S2).

10. Device according to claim 9,
characterized by the fact that
the control unit (7) generates the switching signals as a reaction to operating commands entered by means of an operating unit (16, 17).

11. Device according to claim 10,
characterized by the fact that
the operating commands can be entered by means of a remote control (16) of a television receiver (11) and can be transmitted from a control unit (18) of the television receiver (11) to the control unit (7) of digital radio receiver (1).

12. Device according to one of the preceding claims,
characterized by the fact that the control unit (7) of the digital radio receiver (1) is connected to a control unit of the first additional module (12) via the first interface (6).

13. Device according to one of the preceding claims,
characterized by the fact that
the control unit (7) of the digital radio receiver (1) controls the switching devices (S1, S2), the signal processing units (8, 8a) and the first additional module (12), so that
a coded radio signal, derived from a first transport stream path, is subjected to decoding in the first additional module (12), the decoded radio signal derived from the first transport stream path is transmitted from the first additional module (12) via interface (6) back to the digital radio receiver (1) and sent there to the signal playback device (11) via signal processing unit (8), and
a second coded radio signal, subjected to the same coding as the radio signal derived from the first transport stream, derived from a second transport stream path, is fed via switching devices (S1, S2) in coded form to the memory unit (9).

14. Device according to one of the preceding claims,
characterized by the fact that
the digital radio receiver (1) has several interfaces (6, 6a), via which the digital radio receiver (1) is connected to an additional module (12, 12a), that the output signals of the corresponding additional module are transmitted back to the digital radio receiver (1) via the corresponding interfaces (6, 6a), and each of the additional modules can be connected via the corresponding interfaces (6, 6a) and switching devices to each of the signal sinks (9, 11).

15. Device according to one of the preceding claims,
characterized by the fact that
a higher priority is assigned to one of the radio signals than to the other.

16. Device according to claim 15,
characterized by the fact that
the priority assignment occurs by means of the operating unit.

17. Device according to claim 15 or 16,
characterized by the fact that
it has a memory for a priority list.

18. Device according to one of the claims 13-17,
characterized by the fact that
decoding of the signal stored in coded form, derived from the second transport stream path, occurs after input of a corresponding operating command.

19. Device according to claim 18,
characterized by the fact that
the operating command is a standby command.
